(19) United States
(12) Patent Application Publication
(10) Pub. No.: US 2018/0057942 A1
(43) Pub. Date: Mar. 1, 2018

(54) METHODS FOR MANUFACTURING A HEAT EXCHANGER

(71) Applicant: Unison Industries, LLC, Jacksonville, FL (US)

(72) Inventors: Yang Yanzhe, Mason, OH (US); Michael Thomas Kenworthy, Chandler, AZ (US)

(21) Appl. No.: 15/252,820

(22) Filed: Aug. 31, 2016

(51) Int. Cl. C23C 18/16; B23K 26/342; B23K 26/70; B33Y 10/00; B33Y 80/00; B33Y 40/00; C23C 18/32; F28D 7/16; F28F 21/08

(52) U.S. Cl. CPC C23C 18/1637; B23K 26/342; B23K 26/70; B33Y 10/00; B23K 2201/14; B33Y 40/00; C23C 18/32; F28D 7/16; F28F 21/089; B33Y 80/00

(57) ABSTRACT

A method for manufacturing a heat exchanger including forming a heat exchanger with walls using direct metal laser melting. The walls include defects formed during the direct metal laser melting process. The defects can cause leaking within the heat exchanger. The method includes healing the defects.

### BACKGROUND OF THE INVENTION

Contemporary turbo-prop engine aircraft use heat transfer liquids, such as oil or fuel, to dissipate heat from engine components, such as engine bearing, electrical generators, and the like. Heat is typically rejected from the fluid to another fluid (liquid or air) by heat exchanger assemblies, such as fuel cooled oil coolers or air cooled surface oil coolers, to maintain oil temperatures at a desired temperature.

Fuel cooled oil coolers (FCOC) are heat exchangers used to transfer heat specifically from oil to fuel. Environmental changes can create large variances in ambient temperatures where the fuel is cooler than the oil. Introducing oil to an FCOC enables the fuel and oil to pass by without coming in contact with each other where heat can be exchanged from the oil to the fuel, cooling the heated oil.

In some cases the fuel can drop below the freezing temperature for water due to the surrounding air. Suspended water particles in the fuel can freeze. If an accumulation of frozen water particles in the fuel increases beyond a certain point, blockage in the fuel lines can occur. The cooling of the oil and consequential heat exchange between the oil and the fuel can keep the fuel within a temperature range necessary to prevent blockage. Minimizing wall widths within the FCOC increases the amount of heat exchange and decrease the weight of the heat exchanger.

### BRIEF DESCRIPTION OF THE INVENTION

In one aspect, the present disclosure relates to a method for manufacturing a heat exchanger, comprising the steps of forming a heat exchanger comprising a set of walls forming fluid passages with a direct metal laser melting process, and depositing a layer on at least a portion of the set of walls with an electroless plating process, wherein the set of walls include at least one surface connected defect that spans a width of at least one of the set of walls and the layer and the layer seals the defect.

In another aspect, the present disclosure relates to a method for manufacturing a heat exchanger, comprising the steps of forming a heat exchanger comprising a set of walls forming fluid passages with an additive manufacturing process, and depositing a layer on surfaces of the set of walls, wherein the set of walls include at least one surface connected defect that span from a first surface of at least one of the set of walls to a second surface of the at least one of the set of walls and the layer converts the at least one surface connected defect to an internal defect.

### BRIEF DESCRIPTION OF THE DRAWINGS

In the drawings:

FIG. 1 is a perspective view of an exemplary aircraft having a heat exchanger in accordance with various aspect described herein.

FIG. 2 is a perspective view of an example of the heat exchanger in accordance with various aspects described herein.

FIG. 3 is an enlarged view of a call out portion of the heat exchanger of FIG. 2 in accordance with various aspects described herein.

FIG. 4 is an enlarged view of a call out portion from FIG. 3 of a wall in a “before” scenario for the heat exchanger of FIG. 2 in accordance with various aspects described herein.

FIG. 5 is an enlarged view of a call out portion from FIG. 3 of a wall in an “after” scenario for the heat exchanger of FIG. 2 in accordance with various aspects described herein.

FIG. 6 is a flow chart depicting a method for manufacturing the heat exchanger in FIG. 2 in accordance with various aspects described herein.

### DESCRIPTION OF EMBODIMENTS OF THE INVENTION

The various aspects described herein are related to methods for manufacturing a heat exchanger, in particular the walls of a fuel cooled oil cooler (FCOC), wherein walls having defects can be sealed using a layering process to prevent mixing of the oil and fuel. It will be understood that embodiments of the disclosure can be implemented in any environment, apparatus, or method for sealing thin wall regions regardless of the location of the thin wall regions. As one non-limiting of the environment is an FCOC, the remainder of this application focuses on such an environment.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

Moreover, while “a set of” various elements have been described, it will be understood that “a set” can include any number of the respective elements, including only one element.

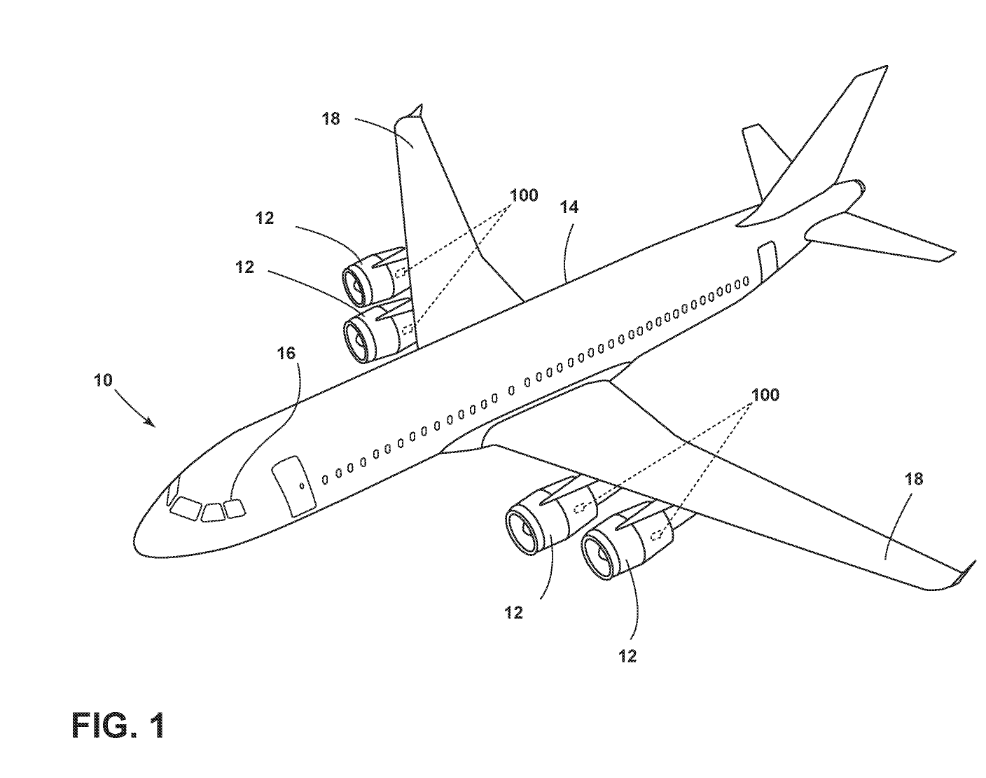

FIG. 1 illustrates an embodiment of the disclosure, showing an aircraft 10 that can include a heat exchanger 100, at one or a plurality of locations as illustrated. The aircraft 10 can include multiple engines, such as gas turbine engines 12, a fuselage 14, a cockpit 16 positioned in the fuselage 14, and wing assemblies 18 extending outward from the fuselage 14.

While a commercial aircraft 10 has been illustrated, it is contemplated that examples disclosed herein can include, but are not limited to, applications in any type of aircraft 10. Further, while two gas turbine engines 12 have been illustrated on the wing assemblies 18, it will be understood that any number of gas turbine engines 12 including a single gas turbine engine 12 on the wing assemblies 18, or even a single gas turbine engine mounted in the fuselage 14 can be included.

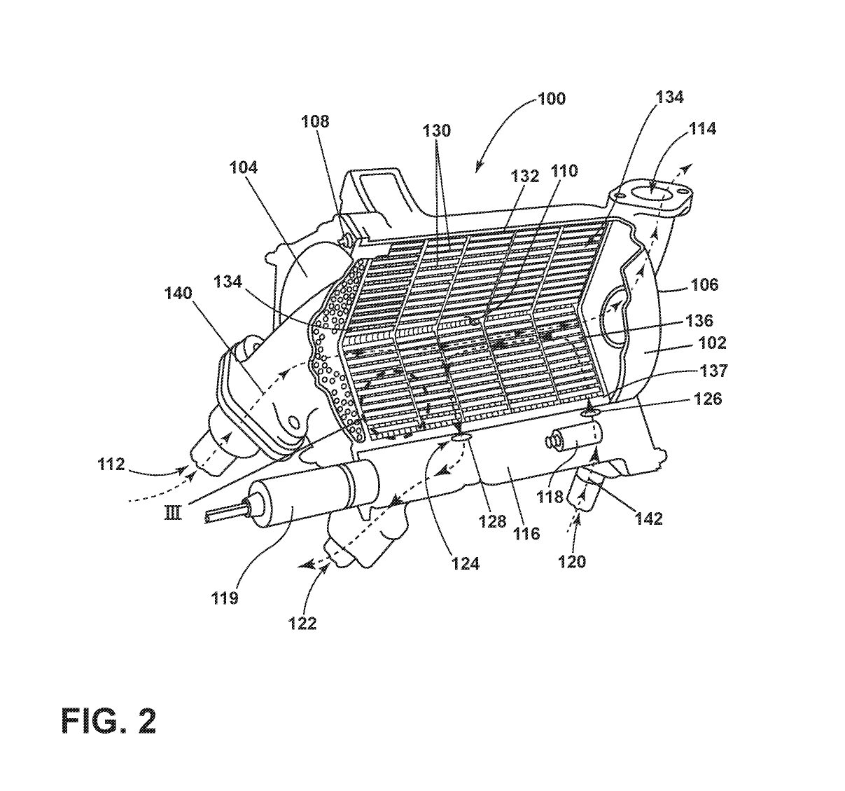

FIG. 2 depicts a perspective view of the heat exchanger 100 having a shell casing 102 terminating in a base 106, the shell casing 102 at least partially defining a cavity 110. A face plate 104 can be mounted to the shell casing 102 at an opposite end from the base 106 to enclose the cavity. The face plate 104 can be coupled to the shell casing 102 in any suitable manner including with any suitable fastening device. The fastening device can include, but is not limited to a bolt and washer assembly 108.

The cavity 110 extends from a cool fluid inlet 112 to a cool fluid outlet 114. The cool fluid inlet 112 can be located in the face plate 104 providing access to the interior 110. The cool fluid outlet 114 can be formed at the base 106 providing an exit from the cavity 110. By way of non-limiting example the cool fluid inlet and outlet can be coupled to a fuel line of the aircraft 10 so as to pass the fuel through the heat exchanger 100 before flowing to the engine 12 for combustion.

A valve assembly 116 can be disposed proximate to the shell casing 102. The valve assembly 116 can include a hot fluid inlet 120 and a hot fluid outlet 122. By way of non-limiting example the hot fluid inlet and outlet can be coupled to an oil pump pack bypassing the oil in the engine 12 and using it to heat up the fuel. A bypass valve 118 coupled with the hot fluid inlet 120 and a temperature transmitter 119 coupled with the hot fluid outlet 122 enable the valve assembly 116 to monitor oil as it enters and exits the heat exchanger for correctly pressure and temperature. The valve assembly 116 can further include one or more access points 124 providing a hot fluid inlet route 126 and a hot fluid exit route 128.

A set of walls 130 including separation walls 132 and manifold walls 134 form fluid passages 136 that define at least a portion of the cavity 110. The fluid passages 136 can be formed as a first and second fluid passage 136a, 136b where the first fluid passage 136a can define a first flow path 140 originating at the cool fluid inlet 112 and terminating at the cool fluid outlet 114. The second fluid passage 136b can define a second flow path 142 originating at the hot fluid inlet 120 and terminating at the hot fluid outlet 122.

The heat exchanger 100 can be any type of heat exchanger 100 having a set of walls 130. By way of non-limiting example the heat exchanger 100 can be a fuel cooled oil cooler (FCOC) in which fuel is the cool fluid that travels along the first flow path 140 and oil is the hot fluid that travels along the second flow path 142. Regardless of the type of fluids within the heat exchanger 100 the set of walls 130 are configured to keep the cool and hot fluids separate and proximate each other so as to exchange heat from the hot fluid to the cool fluid.

The heat exchanger 100 can be formed of any suitable material, for example but not limited to cobalt chrome, aluminum, or titanium. The heat exchanger 100 can be manufactured using additive manufacturing. It should be understood that other methods of manufacturing the heat exchanger 100 can be implemented such as casting in place, sheet metal forming, fusion welding, brazing, or other types of suitable manufacturing processes.

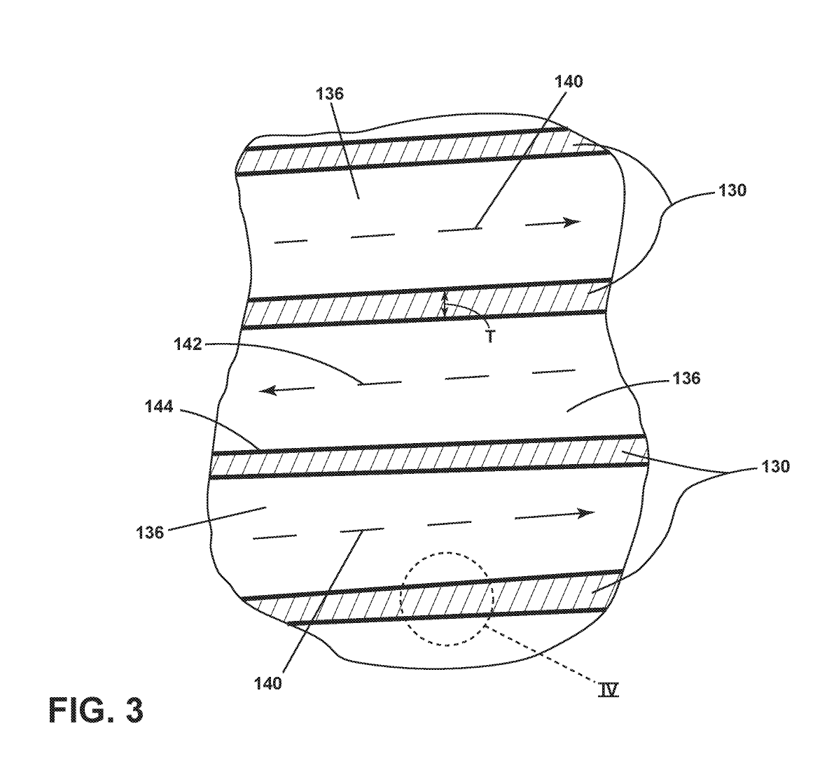

An enlarged view of a call out III in FIG. 2 of the set of walls 130 is depicted in FIG. 3. The set of walls 130 include individual walls having a thickness T of at least 0.006 inches spanning between surfaces 144 that face one of the first and second flow paths 140, 142. While depicted as planar and parallel, it should be understood that the set of walls 130 can be of any shape including but not limited to curved, angular, pointed, or irregular and that the set of walls 130 can include diverging or converging walls. The depiction is for illustrative purposes only.

The set of walls 130 can be formed with a metallic additive manufacturing process known as direct metal laser melting (DMLM) in which a three dimensional CAD model is inputted into a machine with a fiber optic laser capable of melting metal powder and locally fusing it to solid parts. Parts are constructed additively, one layer at a time forming successive layers, each layer being 0.001 to 0.004 inches thick. It can be contemplated that the layers can be deposited in thicker or thinner increments, including but not limited to one layer fulfilling the thickness requirements needed to form the set of walls 130.

It can be better seen in FIG. 3 that the first flow path 140 and the second flow path 142 are separated only by the wall 130 having the thickness T. The first flow path 140 and the second flow path 142 are illustrated as being in a counter-flow arrangement where the first flow path 140 and the second flow path 142 flow in opposite directions. It will be understood that this is by way of non-limiting example only and that the first flow path 140 and the second flow path could alternatively be in a parallel-flow arrangement where the hot and cold fluids in the first flow path 140 and the second flow path 142, respectively, flow in the same direction. Regardless of direction of the first flow path 140 and the second flow path 142 heat can be transferred from the hot fluid traversing the first flow path 140 to cool fluid traversing the second flow path 142.

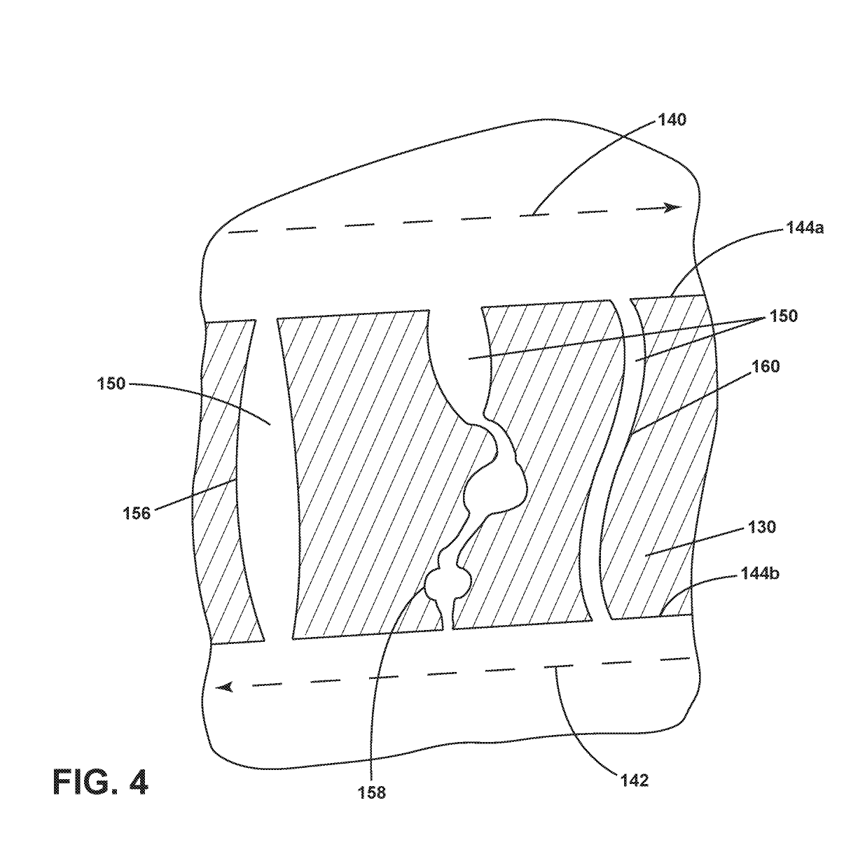

A call out portion IV of part of the set of walls 130 of FIG. 3 is shown in FIG. 4 where at a microscopic level, defects 150 in the set of walls 130, which can occur during manufacturing, are illustrated. These defects 150 can include at least one surface connected defect 150 that can span surfaces 144 that face one of the first and second flow paths 140, 142. More specifically, a first surface, which has been labeled 144a to a second surface labeled as 144b of the set of walls 130. The surface connected defects 150 can include for example, but are not limited to, a large void 156, interconnected small voids 158, or a deep crack 160.

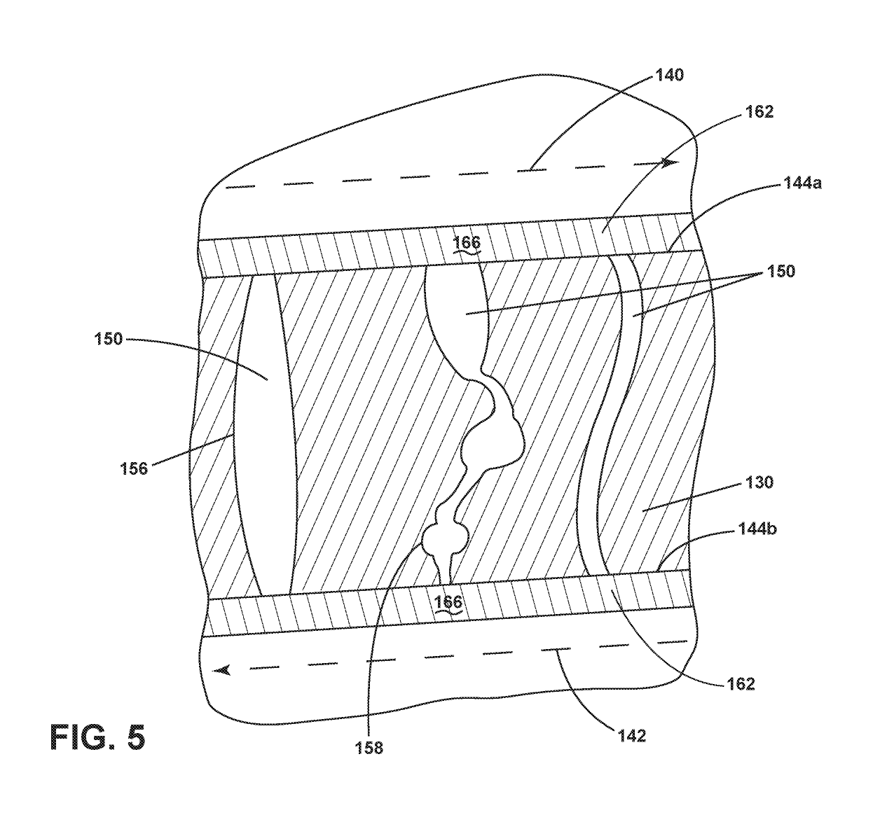

Turning to FIG. 5 a layer 162 on the order of microns to hundreds of microns can be formed on each of the first and second surfaces 144a, 144b to seal the defects 150 converting the surface connected defect 150 to an internal defect 152. The layer 162 can be for example but not limited to nickel alloy, aluminum alloy, copper alloy, or titanium alloy.

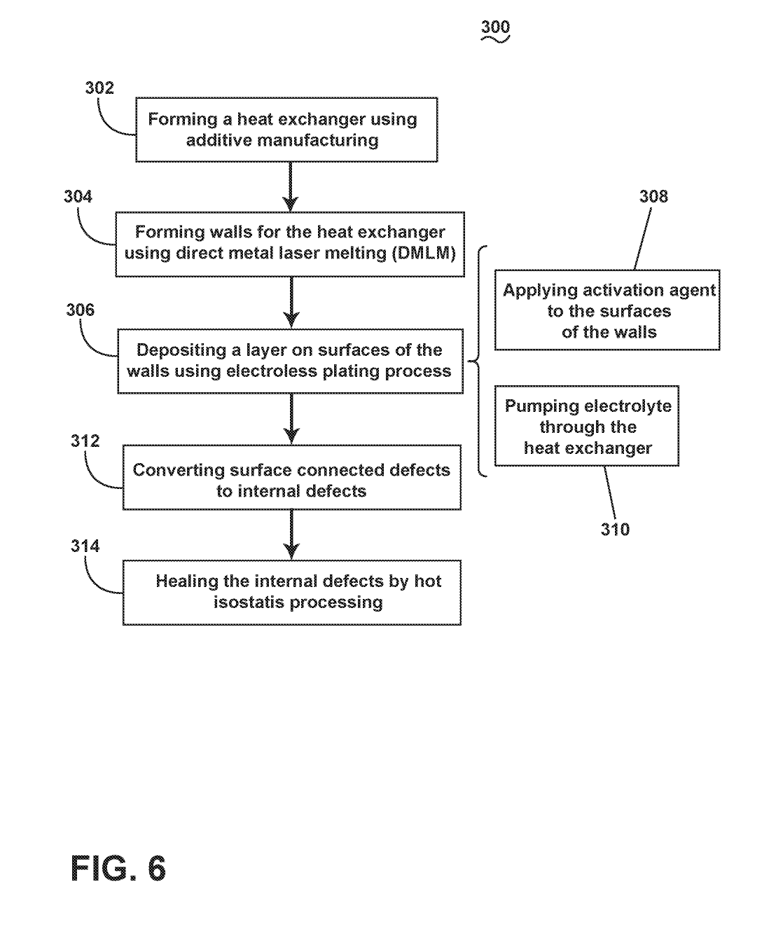

A flow chart illustrating a method 300 for manufacturing the heat exchanger 100 is depicted in FIG. 6. At 302 a heat exchanger 100 is formed using additive manufacturing and at 304 the set of walls 130 is formed using DMLM as described herein. At 306 a layer 162 is deposited on at least a portion of the set of walls 130 using an electroless plating process. The layer 162 can be formed with an electroless plating process including, but not limited to, electroless nickel plating. The electroless plating process includes at 308 applying an activation fluid to at least a portion of the heat exchanger 100 and at 310 pumping electrolyte through the heat exchanger 100. In such a process, an activation agent can be optionally applied to the set of walls 130. The activation agent can include, but is not limited to palladium chloride, hydrofluoric acid.

Electrolyte of nickel ions 166 is pumped through the heat exchanger 100 and deposited on the set of walls 130. Nickel ions 166 reacts with reducing agent so as to deposit as the layer 162. Finally at 312 the surfaces 144 of the walls are converted from having surface connected defects 150 to having internal defects 152. At 314, hot isostatis processing can be utilized to heal the internal defects 152.

While minimizing wall widths within the heat exchanger 100 increases the amount of heat exchanged and decreases the weight of the heat exchanger 100, the DMLM process used can cause voids and micro cracks that can result in leakage through the set of walls 130. Healing the set of walls 130 to prevent the leakage using the method 300 described herein lengthens the life of the heat exchanger 100 by enabling a mechanical fix to an existing heat exchanger 100 with leakage.

Current technology uses hot isostatic pressing to heal sub-surface defects, or voids within the walls of a heat exchanger. The hot isostatic pressing does not include healing surface connect defects, and therefore does not elongate the life of a heat exchanger that has begun to leak. The method described herein of using electroless plating to seal the surfaces of the walls in the heat exchanger provides a fix that both heals the void and eliminates leakage. If required, hot isostatis processing can be further used to heal the defects that are sealed by electroless plating.

To the extent not already described, the different features and structures of the various embodiments can be used in combination with each other as desired. That one feature cannot be illustrated in all of the embodiments is not meant to be construed that it cannot be, but is done for brevity of description. Thus, the various features of the different embodiments can be mixed and matched as desired to form new embodiments, whether or not the new embodiments are expressly described. Combinations or permutations of features described herein are covered by this disclosure. Further, it will be understood that many other possible embodiments and configurations in addition to those shown in the above figures are contemplated by the present disclosure.

This written description uses examples to disclose embodiments of the invention, including the best mode, and also to enable any person skilled in the art to practice embodiments of the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for manufacturing a heat exchanger, comprising the steps of:
forming, via a direct metal laser melting process, a heat exchanger comprising a set of walls forming fluid passages; and
depositing, via a direct metal laser melting process a layer on at least a portion of the set of walls;
wherein the set of walls include at least one surface connected defect that spans a width of at least one of the set of walls and the layer and the layer seals the defect.

2. The method of claim 1 wherein the surface connected defects comprise one of a large void, interconnected small voids, or a deep crack.

3. The method of claim 1 wherein the set of walls comprise outside manifold walls and separation walls.

4. The method of claim 1 wherein the layer is deposited nickel.

5. The method of claim 1 wherein the layer is on an order of microns to hundreds of microns.

6. The method of claim 1 wherein the electroless plating process includes pumping electrolyte through the heat exchanger.

7. The method of claim 6 wherein the electroless plating process includes applying an activation agent to at least a portion of the heat exchanger before pumping electrolyte through the heat exchanger.

8. The method of claim 1 wherein the electroless plating process includes healing internal defects by hot isostatis processing.

9. A method for manufacturing a heat exchanger, comprising the steps of:
forming a heat exchanger comprising a set of walls forming fluid passages with an additive manufacturing process; and
depositing a layer on surfaces of the set of walls;
wherein the set of walls include at least one surface connected defect that span from a first surface of at least one of the set of walls to a second surface of the at least one of the set of walls and the layer converts the at least one surface connected defect to an internal defect.

10. The method of claim 9 wherein the surface connected defects comprise one of a large void, interconnected small voids, or a deep crack.

11. The method of claim 9 wherein the set of walls comprise outside manifold walls and separation walls.

12. The method of claim 9 wherein the forming comprises metallic additive manufacturing.

13. The method of claim 12 wherein the metallic additive manufacturing step includes direct metal laser melting to form at least a portion of the heat exchanger in successive layers.

14. The method of claim 9 wherein the depositing includes converting the at least one surface connected defect to the internal defect.

15. The method of claim 9 wherein the layer is deposited nickel.

16. The method of claim 9 wherein the layer is on the order of microns to hundreds of microns.

17. The method of claim 9 wherein the depositing includes an electroless plating process.

18. The method of claim 17 wherein the electroless plating process includes pumping electrolyte through the heat exchanger.

19. The method of claim 18 wherein the electroless plating process includes applying an activation agent to at least a portion of the heat exchanger before pumping electrolyte through the heat exchanger.

20. The method of claim 19 wherein the electroless plating process includes healing the internal defects by hot isostatis processing.
